(19) United States
(12) Patent Application Publication
(10) Pub. No.: US 2010/0133222 A1
(43) Pub. Date: Jun. 3, 2010

(54) Baby Bottle Preparation

(75) Inventor: David Mathieu, Colchester, CT (US)

Correspondence Address: MCCARTER & ENGLISH, LLP STAMFORD, CANTERBURY GREEN, 201 BROAD STREET, 9TH FLOOR, STAMFORD, CT, 06901, US

(73) Assignee: IDEAZ, LLC, Glastonbury, CT (US)

(21) Appl. No.: 12/528,838

(22) PCT Filed: Feb. 27, 2008
(86) PCT No.: PCT/US08/55189

§ 371 Date: Jan. 15, 2010

Related U.S. Application Data
(60) Provisional application No. 60/891,805, filed on Feb. 27, 2007.

(51) Int. Cl. A61J 9/00; B65B 1/04; B67D 7/76

(52) U.S. Cl. 215/11.3; 141/2; 222/189.06

(57) ABSTRACT

A method of filling a baby bottle is provided which comprises providing a baby bottle containing a hermetically sealed bottle liner, which contains a measured amount of powdered infant formula. The bottle liner comprises a lip retainer for preventing the bottle liner from falling into the bottle. The hermetic seal on the bottle liner may be opened. The method includes disposing filtered, heated water into the liner to mix with the powdered infant formula. A cap and nipple assembly is applied to the bottle.

### BACKGROUND

1. Technical Field

The present disclosure is directed to advantageous apparatus and associated methods/systems for preparing a baby bottle and, more particularly, to apparatus, systems, kits and associated methods for conveniently providing a supply or quantity of warm, sanitized water and conveniently mixing the same with a corresponding supply or quantity of powdered infant formula.

2. Background Art

Infant formula mixed with sanitized water is a primary form of nutrition for babies. Because of its convenience, infant formula is commonly substituted for mother's milk. In this regard, it is recommended that the formula be fed to a baby at a temperature that is as near as possible to that of mother's milk.

Current processes for preparing a baby bottle can involve numerous steps, some of which can be time-consuming. The infant formula itself is typically purchased in containers of concentrated powder weighing approximately one to two pounds and equipped with a scoop used to extract a measured quantity of formula and deposit it in a bottle. Sanitized water (e.g., water that may be boiled to obtain sanitization) is added to the bottle, usually at an elevated temperature in comparison to ambient. After a nipple and a cap are placed on, the bottle is shaken to mix the components and/or cause the formula powder to dissolve into the added water, producing a desired volume of infant formula in a liquid form.

Depending on the temperature of the sanitized water that is added to the bottle (e.g., in instances in which the water used to make the formula is initially boiled to obtain sanitization), the formula may need to be cooled prior to consumption. For example, the bottle may need to be submersed into cold water, a cooling process which often takes more time than a hungry baby has patience for.

Another deficiency in many common bottle preparation processes is that the user may not have an easy and accurate way to measure the temperature of the cooled formula mixture. In such circumstances, a risk exists that the formula will not have been cooled sufficiently to avoid scalding the baby during feeding. Another risk is that the temperature of the formula mixture may have dropped to too great an extent, potentially resulting in the baby rejecting the formula because it is not warm enough. As was alluded to above, most babies prefer infant formula mixture to be close to the normal body temperature of the mother (e.g., approximately ninety-eight (98) degrees Fahrenheit).

An additional process that can be time-consuming involves the cleaning and sanitizing of the actual bottle or container that contains the liquid formula during feeding. Some systems currently available in the marketplace involve the use of bottle liners help to reduce the amount of effort necessary to keep the bottle container sufficiently clean and sanitary.

Despite efforts to date, a need remains for improved apparatus, systems, kits and associated methods for conveniently and quickly preparing a bottle for feeding an infant. Methods are also desired that provide the person preparing the bottle with the benefit of quickly and accurately dispensing the sanitized water, reducing the time required to prepare infant formula-filled baby bottles, and/or providing accurate temperature control to allow immediate consumption without the risk of scalding. Still further, a need remains for inventive apparatus and methods that improve upon the usage of bottle liners and/or with respect to ensuring that an appropriate quantity of formula and is present in the bottle for mixing with and/or dissolving into the sanitized water. In this regard, reliable and effective apparatus and methods are needed for reducing and/or eliminating the need for a person preparing a bottle to specifically measure and/or manually fill the bottle container with the appropriate amount of infant formula concentrate.

These and other needs are addressed by the disclosed apparatus, systems, kits and methods, as will be apparent from the detailed description which follows.

### SUMMARY

The disclosed apparatus, systems, kits and methods operate to make the process of baby bottle preparation faster, more convenient and more accurate, advantageously combining separate activities for installing the bottle liner, formula dosing and water sanitizing. The disclosed apparatus, systems, kits and methods also reduces and/or substantially eliminates the need for the time consuming process of boiling water for sanitization. By combining sanitization and temperature control into the disclosed apparatus, systems, kits and methods, the need for cooling is also reduced and/or substantially eliminated.

In accordance with embodiments of the present invention, an expandable bottle liner is provided, pre-filled with formula concentrate.

In accordance with embodiments of the present invention, an improved baby bottle liner is provided that is convenient to use and can be easily and economically manufactured. The bottle liner may be constructed of a flexible, non-breakable material, e.g., plastic, and allows the liner to expand into the baby bottle.

In accordance with embodiments of the present invention, a disposable baby bottle liner is provided, comprising a bottle liner formed as a bellows with an open end that contains a measured amount of feeding powder. A seal covers the open end of the filled liner and is removably secured thereto to prevent contamination of the feeding powder. A pull tab is integrally formed on the sealing cover to facilitate removal of the sealing cover when it is desired to begin feeding. A lip ring is positioned on the upper exterior surface of the bottle liner proximate its topmost portion and is molded thereto to prevent the bottle liner from falling into the empty bottle. When it is desired to begin filling the bottle with water, the sealing cover may be removed by pulling up on the pull tab. A standard cap and nipple assembly may then be positioned onto the bottle, making it ready for use.

In accordance with embodiments of the present invention, an improved filling means for filling a baby bottle is provided. The filling is accomplished by a filtering, heating and dispensing device for quickly supplying sanitized water at an ideal temperature that is subsequently mixed with powdered infant formula contained in the bottle liner.

In accordance with embodiments of the present invention, an apparatus contains a reservoir where water is added. At such time as the caregiver would like to fill the baby bottle, they activate the apparatus by pressing an electrical switch. The water is then pumped from the reservoir through a filter and past the heating elements to be heated to the ideal temperature and then immediately dispensed into the baby bottle. The reservoir is constructed large enough to provide for multiple feedings. Following the filling of the bottle and upon release of the power switch, the apparatus can complete an automatic sanitization cycle. This cycle may consist of an automatic closure of the water passage between the filter and the heating elements. Secondly, the heating elements are supplied with power to sanitize and heat and dry the flow passage between the filter end point and the exit orifice.

In accordance with embodiments of the present invention, such automatic sanitization can occur both after dispensing and prior to dispensing. The automatic closure may comprise a one-way fluid control valve acting to open during the pumping operation, and to automatically close to prevent air from contaminating the water inside the filter at all other times.

In accordance with embodiments of the present invention, the apparatus can operate in any area that has electricity, and is envisioned to be used both indoors and in an automobile.

In accordance with embodiments of the present invention, a method of filling a baby bottle is provided. The method includes: providing a bottle liner containing a predetermined amount of powdered infant formula, dimensionally and volumetrically compressed along a first direction corresponding to a depth dimension of the baby bottle, and substantially sealed against the entry of ambient air, opening the seal of the bottle liner, allowing the bottle liner to dimensionally and volumetrically expand along the first direction sufficiently so as to accommodate an appropriate amount of water based on the predetermined amount of powdered infant formula, and dispensing filtered, heated water in the appropriate amount into the bottle liner to mix with the powdered infant formula.

In accordance with embodiments of the present invention, a baby bottle liner is provided including a container including walls defining an enclosure containing a predetermined amount of powdered infant formula. The container is dimensionally and volumetrically compressed along a first direction corresponding to a depth dimension of a baby bottle, substantially sealed against the entry of ambient air, and, upon the seal being opened, dimensionally and volumetrically expandable along the first direction sufficiently so as to accommodate an appropriate amount of water for mixing with the powdered infant formula based on the predetermined amount thereof.

In accordance with embodiments of the present invention, a pod for mixing water and powdered infant formula is provided. The pod includes walls defining a body, the body containing a predetermined amount of powdered infant formula, an inlet aperture for admitting water into the body for mixing with the powdered infant formula, an outlet aperture for dispensing a liquid infant formula mixture, and a screen disposed across the outlet aperture, the screen being configured to substantially prevent the infant formula from being dispensed through the outlet aperture in the powdered form, but to permit the infant formula to be dispensed through the outlet aperture upon the same having been mixed with the admitted water sufficiently to dissolve therein.

Additional features, functions and benefits of the disclosed apparatus, systems, kits and methods will be apparent from the description of exemplary embodiments which follow, particularly when read in conjunction with the appended figures.

### BRIEF DESCRIPTION OF THE FIGURES

To assist those of ordinary skill in the art in making and using the disclosed apparatus, systems, kits and associated methods, reference is made to the accompanying figures wherein:

FIG. 1 is a sectional side elevation view of a system for preparing a bottle of baby formula in accordance with embodiments of the present disclosure, wherein the system may include a preparation device, a container positioned with respect to the preparation device, and a pod containing concentrated formula and disposed within the container;

FIG. 2 is downward perspective view of another system for preparing a bottle of baby formula in accordance with embodiments of the present disclosure;

FIG. 3 is cross-sectional side elevation view of a pod containing concentrated formula in accordance with embodiments of the present disclosure;

FIG. 4 is a schematic illustration of a control circuit for controlling a preparation device in accordance with the present disclosure

FIG. 5 is a downward perspective view of multiple instances of another pod containing concentrated formula, some of which are disposed within corresponding pockets of a consumer package in accordance with embodiments of the present disclosure;

FIGS. 6 and 7 are schematic views illustrating sequential steps of a method for preparing a bottle of baby formula in accordance with embodiments of the present disclosure;

FIG. 8 is a downward perspective view of yet another system for preparing a bottle of baby formula in accordance with embodiments of the present disclosure;

FIG. 9 is a downward perspective view of yet another pod containing concentrated formula in accordance with embodiments of the present disclosure;

FIG. 10 is a downward perspective view of still another system for preparing a bottle of baby formula in accordance with embodiments of the present disclosure;

FIG. 11 is a downward perspective view of a bottle of baby formula prepared in accordance with embodiments of the present disclosure;

FIG. 12 is a downward perspective view of a still further pod containing concentrated formula in accordance with embodiments of the present disclosure, the pod being usable in conjunction with various bottles of different sizes;

FIG. 13 is a downward perspective view of a still further system for preparing a bottle of baby formula in accordance with embodiments of the present disclosure;

FIG. 14 is a downward perspective view of a yet further pod containing concentrated formula in accordance with embodiments of the present disclosure;

FIGS. 15, and 16 are schematic views illustrating sequential steps of a further method for preparing a bottle of baby formula in accordance with embodiments of the present disclosure;

FIG. 17 is a downward perspective view of a yet further system for preparing a bottle of baby formula in accordance with embodiments of the present disclosure;

FIG. 18 is a downward perspective view of another bottle of baby formula prepared in accordance with embodiments of the present disclosure;

FIGS. 19 and 20 are schematic sectional side elevation views of respective heating element portions for a preparation device in accordance with embodiments of the present disclosure; and

FIGS. 21, 22 and 23 are schematic sectional side elevation views of additional examples of respective pods containing concentrated formula in accordance with embodiments of the present disclosure.

### DESCRIPTION OF EXEMPLARY EMBODIMENT(S)

Advantageous bottle preparation apparatus, systems, kits and associated methods for the use thereof are provided for conveniently and quickly preparing a bottle for feeding an infant in accordance with to the present disclosure. The disclosed apparatus, systems, kits and methods provide a person preparing a bottle of baby formula with the benefit of quickly and accurately dispensing sanitized water, reducing the time required to prepare infant formula-filled baby bottles, and/or providing accurate temperature control to allow immediate consumption without the risk of scalding. Indeed, the disclosed systems and methods for preparing baby bottles improve upon the usage of bottle liners, including with respect to ensuring that an appropriate quantity of formula and is present in the bottle for mixing with and/or dissolving into the sanitized water. Still further, the present disclosure provides reliable and effective apparatus and methods for reducing and/or eliminating the need for a person preparing a bottle to specifically measure and/or manually fill the bottle container with the appropriate amount of infant formula concentrate.

In accordance with at least some embodiments of the present disclosure, a system and/or kit of components/devices or apparatus, and a method for using the same to prepare baby formula from powder, are provided. For example, at least one such system and/or kit of components/devices, and/or at least one such method, may be described by the following: A system, e.g., a system for preparing a bottle of liquid suitable for consumption by a baby, may include a preparation device. The preparation device may be a freestanding device capable of holding at least some quantity of water (e.g., at least one bottle's worth of cold water or room-temperature water) in a reservoir. A user may select a pod, wherein the pod includes walls defining an enclosure, within which enclosure is contained a quantity of formula (e.g., a predetermined quantity of baby formula, which may be in concentrated form, such as a dry solid and/or a granulate (e.g., a powder), or a concentrated liquid), open the pod (e.g., by removing a covering mounted with respect to the enclosure-defining walls and that seals an interior region of the pod (e.g., a region defined by and/or coextensive with the enclosure) from external contamination, the covering being any means that is sufficiently strong and impermeable to liquids and dirt, such as a suitably thick foil), and place the opened pod into a container (e.g., a bottle, or a bottle-like sleeve). At least until such time as the pod is so opened, the pod itself may be vacuum sealed. The enclosure-defining walls may be constructed of a thin, flexible material that is folded via a plurality of gussets formed along a depth dimension of the pod, such that the folded, gusseted walls are capable of expanding (e.g., expanding downward toward and/or deeper into the container) when opened by virtue of an equalization of air pressure between the inside and the outside of the pod. The pod may be kept in place by a gasket or other surface formed by the walls of the pod and extending over a mouth of the container, thereby preventing the pod from falling into or over the side of the container.

In at least some embodiments in accordance with the present example, the walls of the above-described pod may include exterior walls defining a relatively rigid body, wherein the walls defining the enclosure and/or the expandable liner may be at least substantially contained within the body defined by the exterior walls. More particularly, the walls defining the rigid body may be composed of a material having a strength suitable for use in connection with a baby bottle, and/or may describe a diameter larger than the internal diameter of the baby bottle on which the rigid body may be placed. The walls defining the expandable liner may define an opening at a top portion of the enclosure where the walls defining the expandable liner meet with the walls defining the rigid body. In such circumstances, the above-described gasket or other surface formed by the walls of the pod and extending over a mouth of the container may be at least partially formed by the walls defining the rigid body.

The user may then place the container and pod combination into position with respect to the preparation device (e.g., onto a platform feature associated with the preparation device and beneath a discharge or outlet also associated therewith). The system may further include an interconnection mechanism that connects the preparation device and the pod together, and/or that connects the preparation device and the container and pod combination together. Such an interconnection device may include or contain some means for identifying the pod that has been placed adjacent to it. For example, the identification may include such information as the specific volume of water that is called for to mix with the powder contained within the pod to create the liquid formula. The identifying means may include one or more of a variety of different mechanical, optical, and/or electrical components suitable for the purpose of interrogating the container to be filled, such as one or more mechanical, optical, and/or electrical sensors, keys, or interlocks. In this way, the interconnection device may be capable of functioning as a so-called “smart” interconnect, capable of distinguishing from among a variety of different pod sizes and/or container sizes in such a manner as to permit the preparation device to adjust its function to accommodate such different sizes, and/or of preventing inappropriate or incorrectly-sized pods or containers from connecting to the preparation device in the first place (e.g., fool-proofing the preparation device), thereby obviating at least one source of device malfunction.

The user may, in turn, activate the preparation device to begin a formula-making cycle. Upon the device being so activated, the preparation device may begin pumping and/or routing water from the reservoir, into and/or through a filtering and/or sanitizing element (e.g., an in-line filter element), and into and/or through a heating element (e.g., an in-line heating element). By pumping and/or routing the water into and through the heating element, the preparation device may serve to warm the water to an appropriate temperature in accordance with a selection by the user (e.g., via a thermostat control associated with the preparation device, and/or mounted to a housing thereof, and/or to a chassis associated therewith). The preparation device may then route or dispense the water out of the heating element (e.g., via a discharge outlet associated with the heating element and/or hydraulically coupled thereto) and into the pod. In such circumstances, while the walls of the pod may have previously expanded due to pressure equalization, the same may at this time be caused to expand still further (e.g., by virtue of one or more, or all, of: a downward force associated with the water flowing into the pod, the increasing weight associated with an increasing volume of water contained within the pod, or an elevated temperature of the water as compared to ambient (e.g., room temperature), and/or as compared to a temperature of the pod walls prior to the introduction of warm water into the enclosure thereof.

In accordance with at least some embodiments of the present example, the formula-making cycle may conclude with a drying and/or sanitization step. For example, during this step, the heating element and the discharge outlet may be dried and sanitized. Such a step is beneficial and advantageous, at least insofar as it may serve to prevent water from collecting in the heating element or the discharge outlet, where it could stagnate, and/or where it may foster a growth or bloom of microorganisms, mold, or other undesirable elements on interior surfaces of the heating element or the discharge outlet.

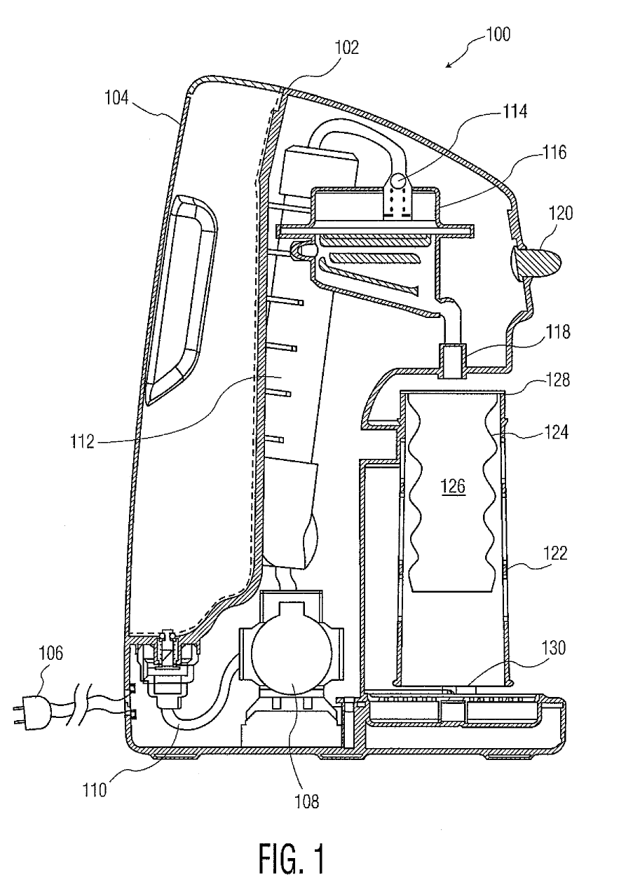

Further exemplary apparatus, systems, kits, and associated methods in accordance with the present disclosure are depicted and described below with reference to FIGS. 1-18. For example, a variety of exemplary systems, kits, preparation devices, formula-containing pods, and corresponding containers are described with reference to FIGS. 1-18 in accordance with the present disclosure. In this regard, one or more of the exemplary systems, kits, preparation devices, pods, and corresponding containers depicted and described below with respect to one subset of FIGS. 1-18 may be variation of (or if not strictly a variation, then at least a modified version of) a corresponding exemplary system, kit, preparation device, pod, or container described above, and/or a corresponding exemplary system, kit, preparation device, pod, or container depicted and described below with respect to another subset of FIGS. 1-18, or vice-versa. In such circumstances, at least some features, aspects, and functions of the exemplary systems, kits, preparation devices, pods, and containers associated with the one subset of FIGS. 1-18 may be substantially similar to those of the exemplary systems, kits, preparation device, pods, and containers described above, and/or to those of the exemplary systems, kits, preparation devices, pods, and containers depicted and described below with respect to the other subset of FIGS. 1-18. In addition, whereas at least some other features, aspects, and functions of the exemplary systems, kits, preparation devices, pods, and containers associated with the one subset of FIGS. 1-18 may be to at least some extent different than those of the exemplary systems, kits, preparation device, pods, and containers described above, and/or than those of the exemplary systems, kits, preparation device, pods, and containers depicted and described below with respect to the other subset of FIGS. 1-18, the same may still be considered analogous thereto. Accordingly, to the extent a below-provided description of the various features, aspects, and functions of exemplary systems, kits, preparation devices, pods, and containers associated with one subset of FIGS. 1-18 is not inconsistent with that associated with another subset of FIGS. 1-18, the latter is hereby incorporated within the former. Similarly, to the extent a below-provided description of the various features, aspects, and functions of exemplary systems, kits, preparation devices, pods, and containers associated with any of FIGS. 1-18 is not inconsistent with a corresponding description of an exemplary system, kit, preparation device, pods, or container provided above, the latter is hereby incorporated within the former.

Referring to FIG. 1, a device 100 for quickly and conveniently preparing a baby bottle may include a housing 102 defining a reservoir 104. The reservoir 104 may, for example, be large enough to receive and retain at least 24 ounces of water, sufficient for at least six 4-ounce baby feedings, or three 8-ounce feedings. The capacity of the reservoir 104 may be larger or smaller. The reservoir 104 may further be removable for purposes of facilitating a process of filling the reservoir 104 with water.

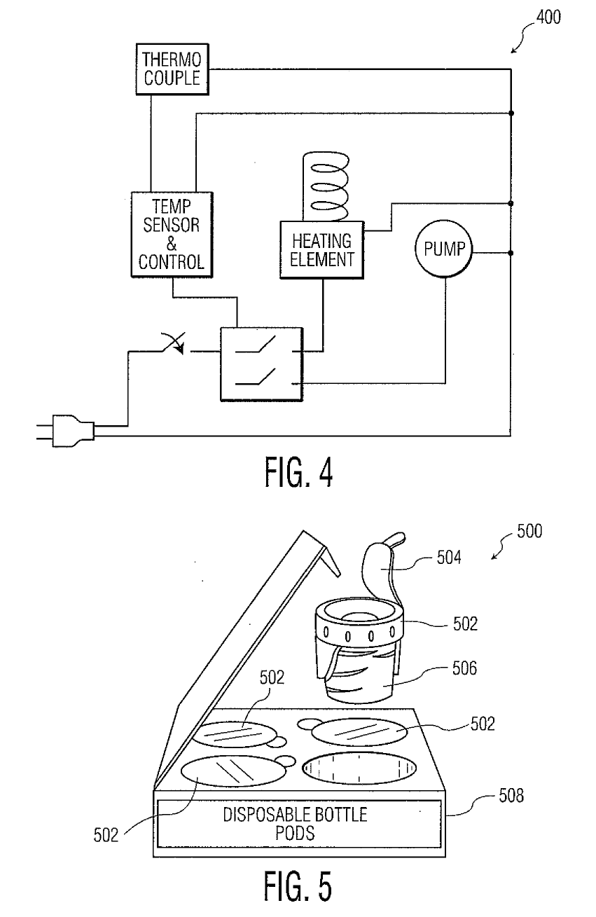

Power to the device 100 may be controlled by a circuit outlined by a schematic 400 provided in FIG. 4 to achieve a desired water temperature and sanitization. Power may be supplied via A/C or D/C current via a plug 106. The device 100 may further include a pump 108 that may include an inlet passage 110, a filter 112, a valve 114, a heating element 116, a discharge outlet 118, and an On/Off switch 120. The On/Off switch 120 may be used for purposes of activating the pump 108 and the heating element 116. This On/Off switch 120 may be configured so as to permit it to be manually depressed by the user.

In accordance with embodiments of the present disclosure, the filter 112 may be an anti-microbial in-line filter. For example, the filter 112 may be three-part Katadyn filter consisting of a 1.0 micron ceramic prefilter (e.g., Katadyn part no. 8015035), activated carbon granulate (e.g., Katadyn part no. 8015036), and an 0.3 micron glass fiber (e.g., Katadyn part no. 8014933). In accordance with embodiments of the present disclosure, the heating element 116 may be self-evacuating, such that water tends not to pool or stagnate inside the heating element.

Upon the On/Off switch 120 being activated by the user, the device 100 may immediately turn on the heating element 116. A momentary delay may occur, after which the pump 108 may be activated. The pump 108 may move water from the reservoir 104, through the inlet passage 110 and the pump 108, then through the valve 114, through the heating element 116 and out of the device 100 via the discharge outlet 118. A bottle 122 may be provided, wherein the bottle 122 may be fitted with a liner 124. The liner 124, which may be collapsible, may include walls defining an enclosure 126, and may be mounted with respect to an upper margin 128 of the bottle, such that the liner 124 may be capable of expanding downward from the upper margin 128, toward and/or into an interior region of the bottle 122. The bottle 122 may be disposed on and/or mounted with respect to a surface 130 of the device 100 positioned beneath the discharge outlet 118. In such circumstances, the now sanitized water may be dispensed through the discharge outlet 118 and into the bottle 122, where it begins to fill the enclosure 126 defined by the walls of the liner 124. Upon filling the bottle 122, the user may release the On/Off switch 120, which may cause the pump 108 to deactivate, and/or cause the flow of water to cease.

Subsequent to the release of the On/Off switch 120, the device 100 may function to provide power to the heating element 116, which may cause the heating element 116 the discharge outlet 118 to dry out, and/or which may further sanitize water-exposed interior surfaces of the heating element 116 and the discharge outlet 118, leaving the device 100 ready for future use Immediately prior to the next use of the device 100, the device 100 may further function to provide power to the heating element 116, which may further ensure that water-exposed interior surfaces of the heating element 116 and the discharge outlet 118 are sanitized at that time.

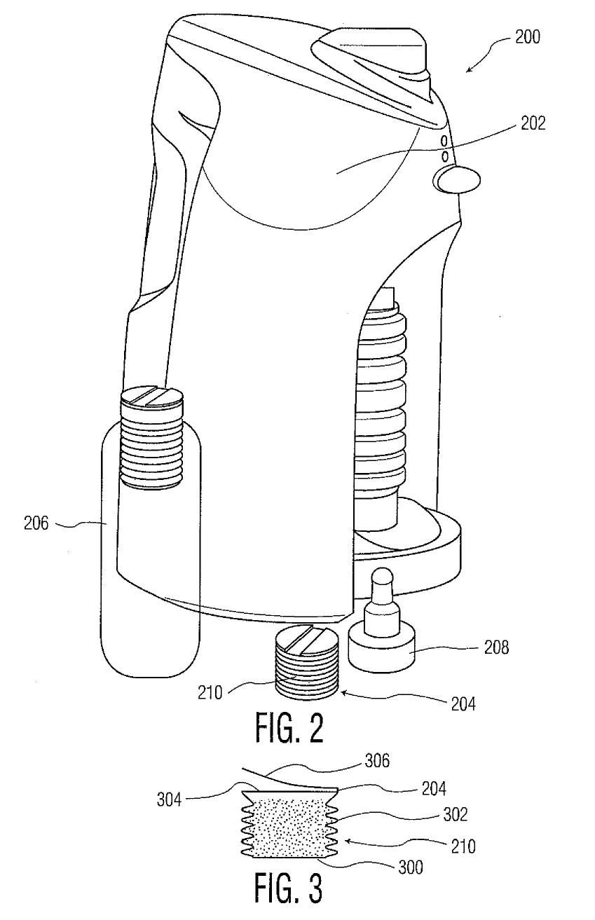

Referring to FIG. 2, a kit 200 or system for quickly and conveniently preparing a baby bottle may include a device 202, a pod 204 (multiple instances of which are shown), a bottle 206, and a nipple/cap combination 208 for fastening on the bottle 206 once the device 202 has been used to dispense warm, sanitized water into an enclosure defined by walls of an extensible liner 210 associated with the pod 204. With respect to one instance of the pod 204, the liner 210 is shown in its collapsed state. The user places the pod 204 into the bottle 206. Referring to FIG. 3, which illustrates the liner 210 of the pod 204 in a collapsed state, the liner 210 of the pod 204 may consist of a thin plastic lower wall 300 and bellows-shaped side walls 302, whereas the pod 204 may further include a substantially rigid upper lip 304 and a removable cover 306.

Turning now to FIGS. 5, 6, 7, and 8, a kit 500 or system in accordance with embodiments of the present disclosure may include multiple instances of a pod 502. The pods 502, each of which may include a removable cover 504 and an extensible liner 506, may be conveniently deposited, transported, sold, and/or stored by a consumer in a package 508 sized and shaped to hold multiple instances (e.g., four (4)) of the pod 502 in a manner that provides easy access to an individual desiring to prepare a baby bottle on short notice.

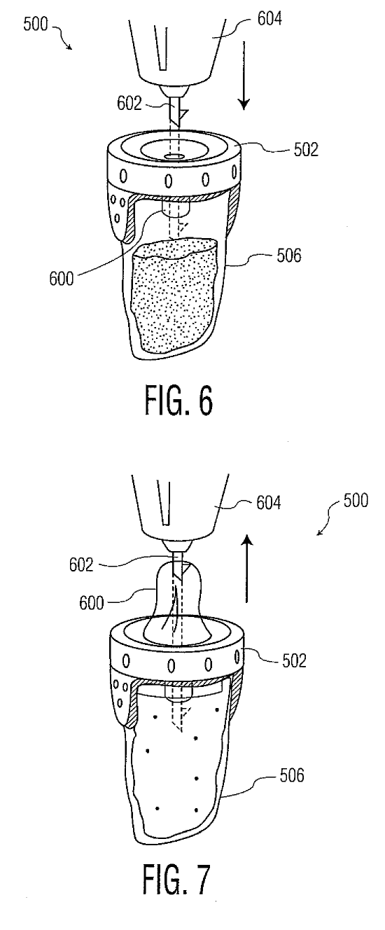

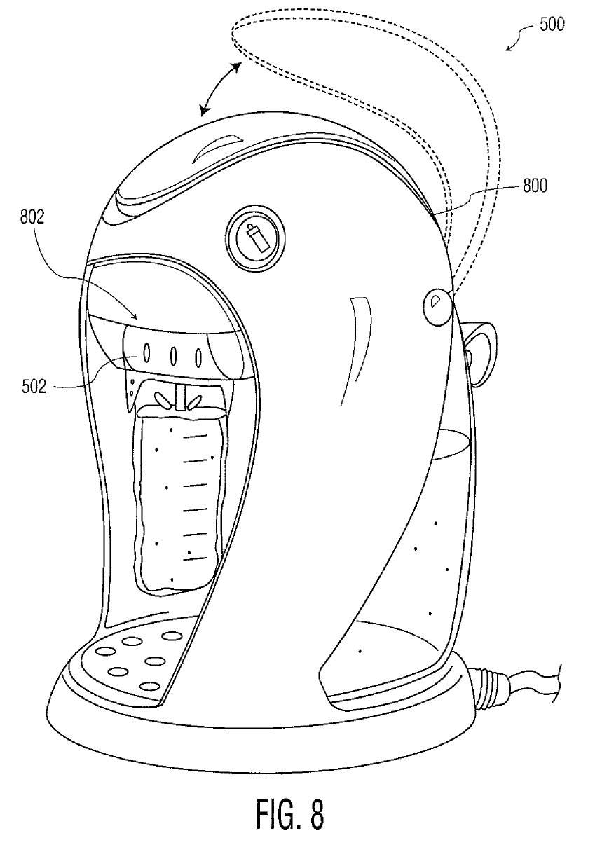

As shown in FIGS. 6 and 7, the pod 502 may further include a nipple 600. In accordance with embodiments of the present disclosure, the nipple 600 may initially extend downward into the liner 506. The kit 500 may further include a needle 602 equipped with an internal passage (obscured) for allowing the needle 602 to at least partially fill the liner 506 of the pod 402 with warm, sanitized water. (The needle 602 may be associated with a fitting 604 configured to securely hold the needle 602 as the same is moved in relation to the pod 502, and/or as the pod 502 is moved in relation to the needle 602, and/or as the needle 602 is moved in relation to the fitting 604 and the pod 502.) As shown in FIG. 6, the nipple 600 may be susceptible to being pierced by the needle 602 during the process of filling the liner 506 with water. As shown specifically in FIG. 7, withdrawal of the needle 602 at the end of a fill cycle may cause the nipple 600 to invert, so that it now extends upward and away from the liner 506. The pods 502 may be disposable. Alternatively, and/or in addition, the pods 502 may be at least partially reusable, and/or recyclable. As shown in FIG. 8, the kit 500 may further include a device 800 for dispensing warm, sanitized water into the pod 502, wherein for such purposes the device 800 may incorporate the needle 602 and the fitting 604 (see FIGS. 6 and 7). The pod 502 may be sized and shaped so as to fit within a corresponding recess 802 in the device 800, wherein the latter may further incorporate an interconnection device (not separately shown) to facilitate coupling the pod 502 to the device 800 (e.g., for purposes of allowing or causing the needle 602 to pierce the nipple 600), and/or for preventing improperly-sized or incompatibly-configured pods or bottles from being used in conjunction with the device.

Turning now to FIGS. 9, 10 and 11, a kit 900 or system for preparing a baby bottle is provided in accordance with embodiments of the present disclosure. As shown in FIG. 9, the kit 900 may include a pod 902. The pod 902 may include an upper margin 904 including a device interface 906, and a cover 908 (e.g., a foil cover) removably disposed atop the device interface 906. In accordance with some embodiments, removal of the cover 908 permits a needle (e.g., see the needle 602 of FIG. 6) to pass into the pod 902 via a corresponding aperture 910 formed in an upper flange 912 of the device interface 906. In accordance with at least some embodiments, removal of the cover permits the aperture 910 to form a hydraulic connection with corresponding features and equipment of a water-dispensing device (not shown). The pod 902 may further include a bladder 914 hydraulically coupled to the device interface 906 and mounted thereto so as to extend generally downward therefrom. The bladder 914 may define a corresponding interior region or enclosure containing a predetermined quantity of formula (e.g., concentrated formula in form of a powder or liquid). The bladder 914 may further include an aperture (not shown) formed along a lower margin of the bladder 914 to permit a water-formula mixture to pass outward of the bladder 914. Alternatively, or in addition, the bladder 914 may include or comprise an extensible bottle liner similar to the liner 124 shown and described with reference to FIG. 1.

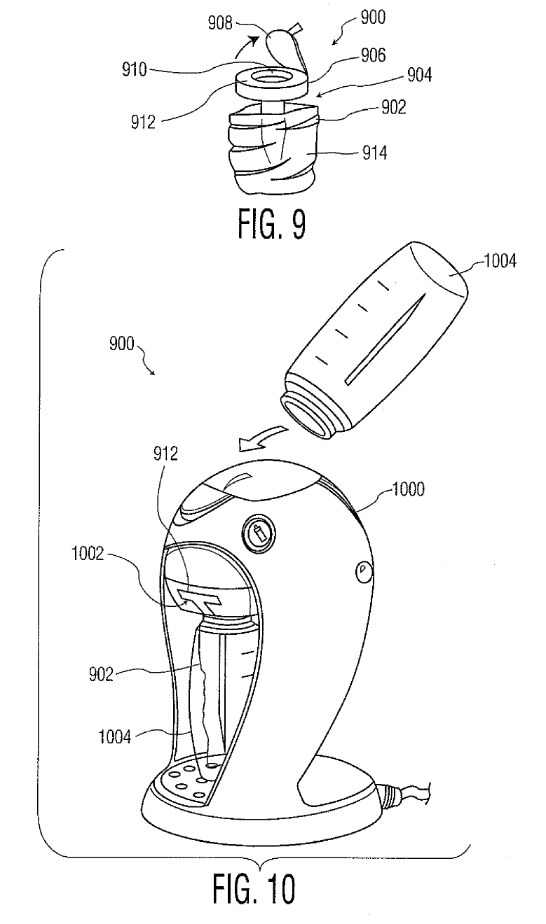

As shown in FIG. 10, the kit 900 may further include a device 1000 for dispensing warm, sanitized water into the pod 902, wherein for such purposes the device 1000 may incorporate the needle 602 and the fitting 604 (see FIG. 6). The upper flange 912 of the device interface 906 (FIG. 9) of the pod 902 may be sized and shaped so as to fit within a corresponding recess 1002 in the device 1000, wherein either or both of the former and the latter may further incorporate an interconnection device (not separately shown) to facilitate coupling the pod 902 to the device 1000 (e.g., for purposes of allowing or causing the needle 602 to pierce the nipple 600), and/or for preventing improperly-sized or incompatibly-configured pods or bottles from being used in conjunction with the device 1000. The kit 900 may further include a bottle 1004, wherein the bottle 1004 may be filled with water (e.g., from the household tap), after which the water in the bottle 1004 may be poured into a receptacle (not separately shown) contained within a housing 1006 of the device 1000. The pod 902 and the bottle 1004 may be assembled together, such that upon the pod 902 being coupled to the device 1000, the bottle 1004 is in turn positioned with respect to (e.g., placed in a resting position on) a supporting surface 1008 of the device 1000. As shown in FIG. 11, the kit 900 may further include a nipple/cap assembly 1100. After the bottle 1004 is filled with warm, sanitized water by the device 1000, the nipple/cap assembly 1100 may be mounted to a corresponding upper margin of the bottle 1004 to form a bottle assembly 1102 that may be shaken as necessary to ensure that the concentrated formula becomes fully dissolved within and/or fully mixed with respect to the warm water. In accordance with embodiments of the present disclosure, part or all of the device interface 906 (FIG. 9) associated with the pod 902 (FIG. 9) may be discarded prior to affixing the nipple/cap assembly 1100 on the bottle 1004. In accordance with some such embodiments, and/or in accordance with at least some other embodiments associated with the present disclosure, the bladder 914 (FIG. 9) associated with the pod 902 (FIG. 9) may be discarded prior to final assembly of the bottle assembly 1102 (e.g., such that it is not necessarily used as a liner for the bottle 1004).

Referring again to FIG. 10, the device 1000 may be configured at least somewhat differently than the device 100 of FIG. 1. For example, water poured into the device 1000 from the bottle 904 (and/or from another decanter, and/or straight from the household tap) may not necessarily be stored in a removable reservoir (e.g., a removable reservoir such as the reservoir 104 of the device 100 of FIG. 1). More particularly, while it may lack a voluminous removable reservoir, the device 1000 may include an interior reservoir (not shown) having a somewhat reduced capacity (e.g., a capacity roughly corresponding to the capacity of the bottle 904) such that the device 1000 may be considered suitable for use as a “single serve” bottle-filling device.

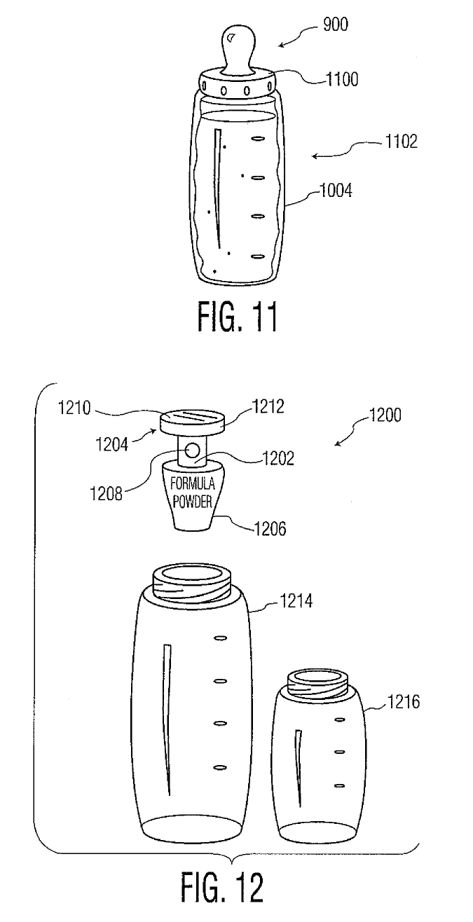

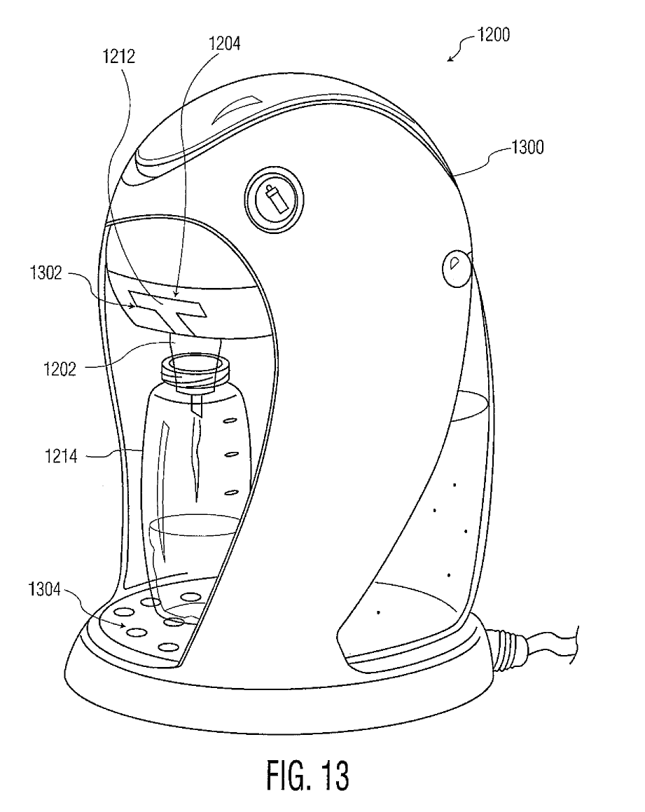

Turning now to FIGS. 12 and 13, a kit 1200 or system for preparing a baby bottle is provided in accordance with embodiments of the present disclosure. As shown in FIG. 12, the kit 1200 may include a pod 1202. The pod 1202 may include a device interface 1204 and a body 1206 hydraulically coupled to the device interface 1204 and mounted thereto so as to extend generally downward therefrom. The body 1206 may define a corresponding interior region or enclosure containing a predetermined quantity of formula (e.g., concentrated formula in form of a powder or liquid). The body 1206 may further include an aperture (not shown) formed along a lower margin of the body 1206 to permit a water-formula mixture to pass outward of the pod 1202. For example, the body 1206 may include a perforated bottom surface, and/or may incorporate a screen and/or a filter (not shown) comprising part or all of a bottom surface of the body 1206. In accordance with embodiments of the present disclosure, the body 1206 may be used as and/or double as a discharge outlet, as described further hereinafter.

The device interface 1204 may further include a valve 1208. For example, the valve 1208 may be an anti-backflow valve (e.g., a ball valve) configured to permit warm, sanitized water to flow into the body 1206 while at the same time preventing either water, or a water-formula mix, to flow upward from the body 1206 (e.g., back into and/or through the device interface 1204).

The pod 1202 may include a cover 1210 (e.g., a foil cover) removably disposed atop the device interface 1204. In accordance with some embodiments, the cover 1210 covers an aperture (obscured) formed in an upper flange 1212 of the device interface 1204, such that removal of the cover 1210 permits the aperture (obscured) to form a hydraulic connection with corresponding features and equipment of a water-dispensing device (not shown). In accordance with embodiments of the present disclosure, the pod 1202 is compatible with bottles of different sizes (e.g., such as a eight-ounce bottle 1214, or a four-ounce bottle 1216).

As shown in FIG. 13, the kit 1200 may further include a device 1300 for dispensing warm, sanitized water into the pod 1202. The upper flange 1212 of the device interface 1204 of the pod 1202 may be sized and shaped so as to fit within a corresponding recess 1302 in the device 1300, wherein either or both of the former and the latter may further incorporate an interconnection device (not separately shown) to facilitate coupling the pod 1202 to the device 1300, and/or for preventing improperly-sized or incompatibly-configured pods or bottles from being used in conjunction with the device 1300. The pod 1202 and a bottle (e.g., bottle 1214) may be assembled together, such that upon the pod 1202 being coupled to the device 1300, the bottle 1214 is in turn positioned with respect to (e.g., placed in a resting position on) a supporting surface 1304 of the device 1300. The device 1300 may then be used to fill the bottle 1214 with a mixture of formula and water, after which a nipple/cap assembly (not shown) may be mounted to the bottle 1214 to form an unlined bottle assembly (not shown) that may be shaken as necessary to ensure that formula in the water-formula mixture becomes fully dissolved. In accordance with embodiments of the present disclosure, the entire pod 1202 may be discarded prior to affixing the nipple/cap assembly (not shown) on the bottle 1214.

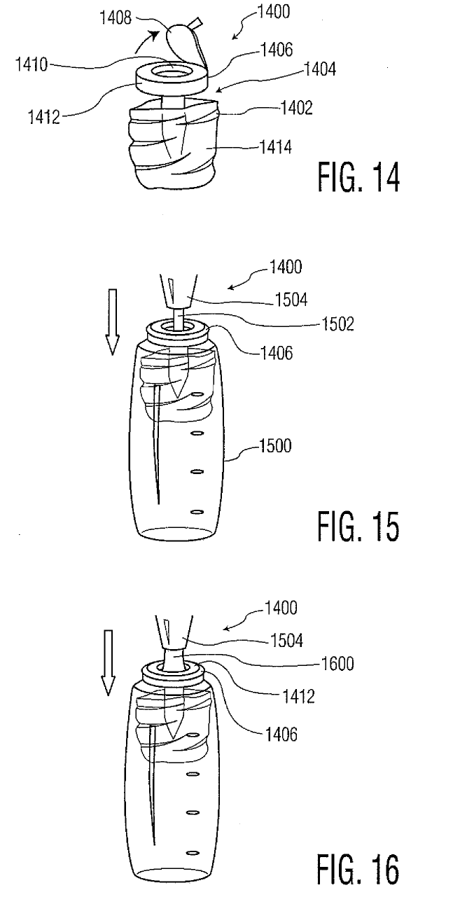

Turning now to FIGS. 14, 15, 16, 17 and 18, a kit 1400 or system for preparing a baby bottle is provided in accordance with embodiments of the present disclosure. As shown in FIG. 14, the kit 1400 may include a pod 1402. The pod 1402 may include an upper margin 1404 including a device interface 1406, and a cover 1408 (e.g., a foil cover) removably disposed atop the device interface 1406. In accordance with some embodiments, removal of the cover 1408 permits a needle (e.g., see the needle 602 of FIG. 6) to pass into the pod 1402 via a corresponding aperture 1410 formed in an upper flange 1412 of the device interface 1406. In accordance with at least some embodiments, removal of the cover 1408 permits the aperture 1410 to form a hydraulic connection with corresponding features and equipment of a water-dispensing device (not shown). The pod 1402 may further include a bladder 1414 hydraulically coupled to the device interface 1406 and mounted thereto so as to extend generally downward therefrom. The bladder 1414 may define a corresponding interior region or enclosure containing a predetermined quantity of formula (e.g., concentrated formula in form of a powder or liquid). The bladder 1414 may further include an aperture (not shown) formed along a lower margin of the bladder 1414 to permit a water-formula mixture to pass outward of the bladder 1414. Alternatively, or in addition, the bladder 1414 may include or comprise an extensible bottle liner similar to the liner 124 shown and described with reference to FIG. 1.

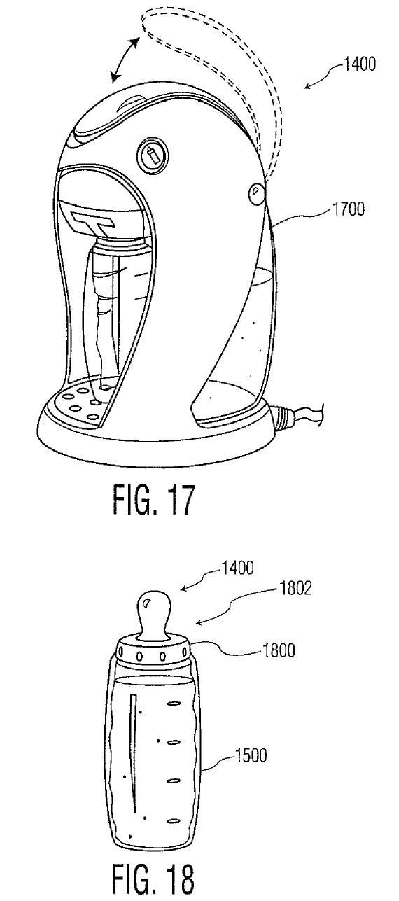

As shown in FIG. 15, the kit 1400 may further include a bottle 1500 in which the pod 1402 is contained, and the pod 1402 may further include a needle 1502 equipped with an internal passage (obscured) for allowing the needle 1502 to dispense warm, sanitized water into the pod 1402. (The needle 1502 may be associated with a fitting 1504 configured to securely hold the needle 1502 as the same is moved in relation to the pod 1402, and/or as the pod 1402 is moved in relation to the needle 1402, and/or as the needle 1502 is moved in relation to the fitting 1504 and the pod 1402.) As shown in FIG. 15, the device interface 1406 may be susceptible to being pierced by the needle 1502 during the process of dispensing water into the pod 1402. As an alternative, and as shown in FIG. 16, the kit 1400 may not include a needle 1502, but rather include a nozzle 1600 (e.g., extending from the fitting 1504), wherein the upper flange 1412 of the device interface 1406 may form a hydraulic seal with the nozzle 1600. As shown in FIG. 17, the kit 1400 may further include a device 1700 for dispensing warm, sanitized water into the pod 1402, wherein for such purposes the device 1700 may incorporate the needle 1502 and the fitting 1504 (FIG. 15). The pod 1402 may be sized and shaped so as to fit within a corresponding recess 1702 in the device 1700.

As shown in FIG. 18, the kit 1400 may further include a nipple/cap assembly 1800. After the bottle 1500 is filled with warm, sanitized water by the device 1700, the nipple/cap assembly 1800 may be mounted to a corresponding upper margin of the bottle 1500 to form a bottle assembly 1802 that may be shaken as necessary to ensure that the concentrated formula becomes fully dissolved within and/or fully mixed with respect to the warm water. In accordance with embodiments of the present disclosure, part or all of the device interface 1406 (FIG. 14) associated with the pod 1402 (FIG. 14) may be discarded prior to affixing the nipple/cap assembly 1800 on the bottle 1500. In accordance with some such embodiments, and/or in accordance with at least some other embodiments associated with the present disclosure, the bladder 1414 (FIG. 14) associated with the pod 1402 (FIG. 14) may be discarded prior to final assembly of the bottle assembly 1802 (e.g., such that it is not necessarily used as a liner for the bottle 1500).

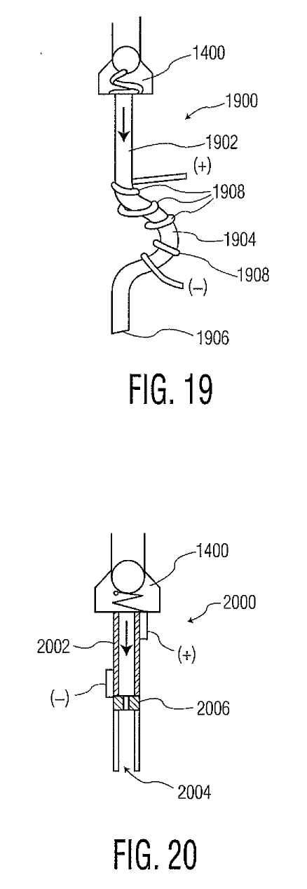

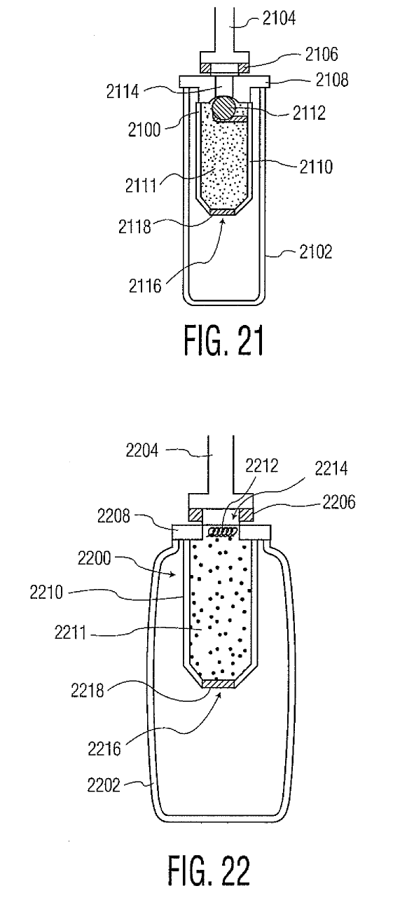

Referring now to FIGS. 19 and 20, respective heating elements 1900, 2000 are shown in accordance with embodiments of the present disclosure. Each of the heating elements 1900, 2000 may be incorporated in a device (not separately shown) for preparing a baby bottle in accordance with the present disclosure. For example, the device 100 (FIG. 1) may be modified to include either of the respective heating elements 1900, 2000 in replacement of the heating element 116 thereof. As shown in FIG. 19, relatively cool water may be passed or pumped through the valve 114 (see also FIG. 1) into the heating element 1900, which may include a substantially vertically-oriented tube 1902 which includes a horizontal jog 1904 leading to an end aperture 1906, and a plurality of heat coils 1908 disposed around the tube 1902 in the vicinity of the horizontal jog 1904.

As shown in FIG. 20, relatively cool water may be passed or pumped through the valve 114 (see also FIG. 1) into the heating element 2000, which may include a substantially straight and vertically-oriented heating tube 2002, an end aperture 2004, and a flow restriction device (e.g., an orifice) 2006. Each of the heating element 1900 (FIG. 19) and the heating element 2000 is advantageous, at least because it is naturally self-draining (e.g., for purposes of avoiding water pooling or stagnation), in addition to being self-sanitizing.

Turning now to FIG. 21, a pod 2100 is depicted, lodged within a bottle 2102 (e.g., a 4-ounce bottle) and forming a water-tight seal with a discharge outlet 2104 (e.g., via a rubber seal 2106 disposed between the discharge outlet 2104 and an upper flange 2108 of the pod 2100). The pod may include a body 2110, within which is disposed a quantity 2111 of formula (e.g., powder formula concentrate). The pod 2100 may further include a valve 2112 (e.g., a one-way ball valve) for preventing reverse flow through an aperture 2114 formed in the upper flange 2108 of the pod 2100. The pod 2100 may still further include an aperture 2116 and a screen 2118 disposed across the aperture 2116 that functions to prevent dry powder formula from escaping from the pod 2100, but is susceptible to wetting and for permitting dissolved formula to pass out of the pod 2100 and into the bottle 2102. Once the bottle 2102 is filled, the pod 2100 may be disposed of in its entirety.

Turning now to FIG. 22, a pod 2200 is depicted, lodged within a bottle 2202 (e.g., a 8-ounce bottle) and forming a water-tight seal with a discharge outlet 2204 (e.g., via a rubber seal 2206 disposed between the discharge outlet 2204 and an upper flange 2208 of the pod 2200). The pod may include a body 2210, within which is disposed a quantity 2211 of formula (e.g., powder formula concentrate). The pod 2200 may further include an anti-splash filter 2212 (e.g., comprised of a sponge-type material or other suitable material) for regulating flow through an aperture 2214 formed in the upper flange 2208 of the pod 2200, wherein the anti-splash filter 2212 prevents reverse flow through the aperture 2214 by a combination of positive pressure from water flow through the discharge outlet 2204 and a blocking function naturally performed by the material of the filter 2212. The pod 2200 may still further include an aperture 2216 and a screen 2218 disposed across the aperture 2216 that functions to prevent dry powder formula from escaping from the pod 2200, but is susceptible to wetting and for permitting dissolved formula to pass out of the pod 2200 and into the bottle 2202. Once the bottle 2202 is filled, the pod 2200 may be disposed of in its entirety.

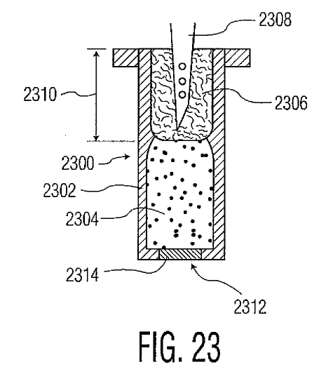

Turning now to FIG. 23, a pod 2300 is depicted. The pod may include a body 2302, within which is disposed a quantity 2304 of formula (e.g., powder formula concentrate). The pod 2300 may further include a sponge filter 2306 disposed above the quantity 2304 of formula for receiving a needle 2308 that pierces the pod 2300 to an extent of a fractional portion of an overall depth dimension 2310 of the sponge filter 2306. The sponge filter 2306 regulates water flow within the body 2302 of the pod 2300, wherein the sponge filter 2306 prevents reverse flow through back toward the needle 2308 by a combination of positive pressure from water flow through the needle 2308 and a blocking function naturally performed by the material of the filter 2306. The pod 2300 may still further include an aperture 2312 and a screen 2314 disposed across the aperture 2312 that functions to prevent dry powder formula from escaping from the pod 2300, but is susceptible to wetting and for permitting dissolved formula to pass out of the pod 2300. Once the corresponding bottle (not shown) is filled, the pod 2300 may be disposed of in its entirety.

Although implementations of the invention have been described in detail above, those skilled in the art will readily appreciate that many additional modifications are possible without materially departing from the novel teachings and advantages of the invention. Any such modifications are intended to be included within the scope of the invention as defined in the following claims.

1. A method of filling a baby bottle, comprising:
a) providing a bottle liner containing a predetermined amount of powdered infant formula, dimensionally and volumetrically compressed along a first direction corresponding to a depth dimension of the baby bottle, and substantially sealed against the entry of ambient air;
b) opening the seal of the bottle liner, allowing the bottle liner to dimensionally and volumetrically expand along the first direction sufficiently so as to accommodate an appropriate amount of water based on the predetermined amount of powdered infant formula; and
c) dispensing filtered, heated water in the appropriate amount into the bottle liner to mix with the powdered infant formula.

2. The method of filling a baby bottle of claim 1, further comprising providing a bottle containing the bottle liner, and, after the dispensing step (c), applying a cap and nipple assembly to the bottle.

3. (canceled)

4. The method of filling a baby bottle of claim 1, wherein the bottle liner comprises a lip retainer for preventing the bottle liner from falling into the bottle.

5. The method of filling a baby bottle of claim 4, wherein the lip retainer comprises a lip ring for fitting about a circular opening of the baby bottle.

6. The method of filling a baby bottle of claim 1, wherein the opening the seal step (b) further comprises using separation means for opening the seal of the bottle liner.

7. The method of filling a baby bottle of claim 6, wherein the separation means comprises a pull tab.

8. (canceled)

9. The method of filling a baby bottle of claim 1 wherein the dispensing step (c) further comprises pumping water from a reservoir through a filter, then through an automatic, selectively openable closure, followed by a heating element, and then out through an exit nozzle.

10. The method of filling a baby bottle of claim 9 wherein the dispensing step (c) is alternated with a heating step to sanitize and dry the heating element and exit nozzle.

11. The method of filling a baby bottle of claim 10, wherein the heating step includes wherein the heating element sanitizes and dries itself and the exit nozzle.

12. A baby bottle liner, comprising:
a container including walls defining an enclosure containing a predetermined amount of powdered infant formula, the container being further:
dimensionally and volumetrically compressed along a first direction corresponding to a depth dimension of a baby bottle;
substantially sealed against the entry of ambient air; and
upon the seal being opened, dimensionally and volumetrically expandable along the first direction sufficiently so as to accommodate an appropriate amount of water for mixing with the powdered infant formula based on the predetermined amount thereof.

13. (canceled)

14. The baby bottle liner of claim 12, wherein the container further includes separable means for opening the seal.

15. The baby bottle liner of claim 12 wherein the container includes a bladder dimensionally and volumetrically expandable along the first direction.

16. The baby bottle liner of claim 15 wherein the bladder includes a side wall, and wherein at least one expandable gusset is disposed in the side wall of the bladder.

17. The baby bottle liner of claim 12, wherein the container comprises a heat sealable polymeric film.

18. (canceled)

19. The baby bottle liner of claim 12 further comprising a weakened separable portion in the container for opening the seal.

20. A pod for mixing water and powdered infant formula, the pod comprising:
walls defining a body, the body containing a predetermined amount of powdered infant formula;
an inlet aperture for admitting water into the body for mixing with the powdered infant formula;
an outlet aperture for dispensing a liquid infant formula mixture; and
a screen disposed across the outlet aperture, the screen being configured to substantially prevent the infant formula from being dispensed through the outlet aperture in the powdered form, but to permit the infant formula to be dispensed through the outlet aperture upon the same having been mixed with the admitted water sufficiently to dissolve therein.

21. The pod of claim 20, further comprising means for preventing a reverse flow of formula away from the outlet aperture and toward the inlet aperture disposed within the body between the inlet aperture and the outlet aperture.

22. The pod of claim 21, wherein the means for preventing a reverse flow includes a one-way valve.

23. (canceled)

24. The pod of claim 21, wherein the means for preventing a reverse flow includes an anti-splash filter.

25. The pod of claim 24, wherein the anti-splash filter is comprised of a sponge-type material.
